(19) United States
(12) Patent Application Publication
(10) Pub. No.: US 2023/0226635 A1
(43) Pub. Date: Jul. 20, 2023

(54) Method and Apparatus for Welding Workpieces

(71) Applicant: Fronius International GmbH, Pettenbach (AT)

(72) Inventors: Peter Lattner, Pettenbach (AU); Martin Willinger, Pettenbach (AU)

(21) Appl. No.: 18/007,115

(22) PCT Filed: Jul. 30, 2021
(86) PCT No.: PCT/EP2021/071397

§ 371 Date: Jan. 27, 2023

(30) Foreign Application Priority Data
Jul. 31, 2020 (DE) 10 2020 209 717.8

(51) Int. Cl. B23K 9/167; B23K 9/073; B23K 9/09; B23K 9/067; B23K 9/095

(52) U.S. Cl. CPC B23K 9/167; B23K 9/0738; B23K 9/093; B23K 9/092; B23K 9/0673; B23K 9/0953

(57) ABSTRACT

A welding apparatus for welding workpieces by means of a welding arc which is ignited between a non-consumable welding electrode and the workpieces and produces a molten pool, wherein the welding is performed in a welding process including a plurality of welding cycles, the parameters of which can be set via an interface of the welding apparatus. Each welding cycle of the welding process has a high-current welding phase, during which a high welding current flows, and a low-current welding phase, during which a low welding current flows. In the high-current welding phase and/or in the low-current welding phase of, with the relevant welding cycle being set accordingly, current pulses can be applied, and at the beginning of the high-current welding phase, with the relevant welding cycle being set accordingly, high-frequency ignition pulses can be applied for the contactless ignition of the welding arc.

### FIELD OF THE INVENTION

The invention relates to a method and an apparatus for welding workpieces by a welding arc by means of a welding electrode, in particular with a non-consumable tungsten welding electrode.

### BACKGROUND OF THE INVENTION

In the case of arc welding, an electric arc or welding arc SLB burns between a workpiece and a welding electrode. In the case of Tungsten Inert Gas (TIG) welding, a welding electrode consisting of tungsten is used. In contrast to other conventional arc welding methods, in the case of TIG welding methods the welding electrode used does not melt by reason of the high melting point of tungsten. The required weld metal is held in the form of wires or bars in the welding arc and is melted in this manner. In order to ensure that the melted material does not react with the ambient air, protective gases are preferably used which are inert, i.e., they do not undergo a chemical reaction with the materials involved. In the case of TIG welding, only a few weld spatters are produced. Moreover, since the welding electrode used is non-consumable, the addition of the filler metal or weld metal and the current intensity of the welding current are decoupled from one another. This offers the advantage that the welding current for the welding process can be adjusted relatively easily and only a required amount of weld metal is actually supplied.

However, since in the case of interval welding the non-consumable welding electrode cools down during a pause time, ignition problems can occur under certain circumstances during ignition of the welding arc. After ignition of the welding arc, the non-consumable welding electrode is supplied with energy from a current source of the welding apparatus. In so doing, it is important that the energy input into the workpiece during the welding process is within a suitable range in order, on the one hand, to provide sufficient energy to produce a molten pool, and, on the other hand, to prevent excessively high energy input.

### SUMMARY OF THE DISCLOSURE

Therefore, it is an object of the present invention to provide a method and an apparatus for welding workpieces by a welding arc by means of a non-consumable welding electrode, in which the welding arc is reliably ignited and the energy input into the workpiece during the welding process can be set in an optimised manner.

Accordingly, the invention provides a method for welding workpieces by a welding arc which is ignited between a non-consumable welding electrode and the workpieces and produces a molten pool, wherein the welding of the workpieces is performed in a welding process including settable welding cycles which each have a high-current welding phase, during which a high welding current flows, and a low-current welding phase, during which a low welding current to no welding current flows, wherein, in the high-current welding phase of the welding cycle and/or in the low-current welding phase (NSP) of the welding cycle, with the relevant welding cycle being set accordingly, current pulses are applied, and wherein, at the beginning of the high-current welding phase, with the relevant welding cycle being set accordingly, high-frequency ignition pulses are applied for the contactless ignition of the welding arc.

In one possible embodiment of the method in accordance with the invention, a characteristic curve used in the welding process includes a plurality of welding cycles, the parameters of which are set via an interface.

In one possible embodiment of the method in accordance with the invention, the parameters of a welding cycle according to the characteristic curve include, in particular,
a time duration of the high-current welding phase,
a time duration of the low-current welding phase,
a ratio of the time duration of the high-current welding phase to a time duration of the low-current welding phase,
a current amplitude of the welding current flowing in the high-current welding phase,
a current amplitude of the welding current flowing in the low-current welding phase,
a ratio of the current amplitudes of the welding current flowing in the high-current welding phase to the current amplitude of the welding current flowing in the low-current welding phase,
an amplitude and frequency of the current pulses applied during welding in the high-current welding phase and/or in the low-current welding phase, an amplitude, frequency and polarity of the ignition pulses which can be applied at the beginning of the high-current welding phase.

In a further possible embodiment of the method in accordance with the invention, the current amplitude of the welding current flowing in the low-current welding phase of the welding cycle is set in a range between 0 and 10 amp.

In a further possible embodiment of the method in accordance with the invention, parameters of the welding cycles of a welding job are set manually by a user or welder by means of a user interface before or during the welding process.

A welding arc is produced at this location in dependence upon the level of the welding current in the low-current welding phase.

In a further possible embodiment of the method in accordance with the invention, the current amplitudes of the high-current welding phases of welding cycles within a welding job increase in a ramp-like manner at the start, then remain at a constant level and decrease in a ramp-like manner at the end.

In a further possible embodiment of the method in accordance with the invention, the current amplitudes of the high-current welding phases are up to 1000 amp.

Accordingly, the invention provides a welding apparatus for welding workpieces by means of a welding arc which is ignited between a non-consumable welding electrode of the welding apparatus and the workpieces and produces a molten pool,
wherein the welding of the workpieces is performed in a welding process including a plurality of welding cycles, the parameters of which can be set via an interface of the welding apparatus,
wherein each welding cycle of the welding process has a high-current welding phase, during which a high welding current flows, and a low-current welding phase, during which a low welding current flows,
wherein, in the high-current welding phase of the welding cycle, with the relevant welding cycle being set accordingly, current pulses are applied, and wherein, at the beginning of the high-current welding phase, with the relevant welding cycle being set accordingly, high-frequency ignition pulses can be applied for the contactless ignition of the welding arc.

Possible embodiments of the welding method in accordance with the invention and the welding apparatus in accordance with the invention will be explained in greater detail hereinafter with reference to the enclosed figures.

### BRIEF DESCRIPTION OF THE DRAWINGS

In the drawings:

FIG. 1 shows an exemplified embodiment of a welding apparatus in accordance with the invention;

FIGS. 2A to 8 show signal diagrams for explaining the mode of operation of the welding method in accordance with the invention.

### DETAILED DESCRIPTION

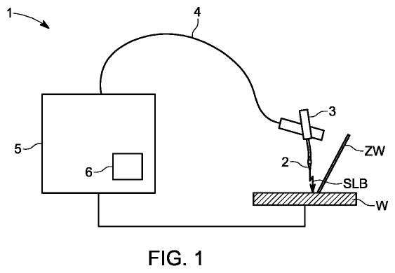

FIG. 1 shows an exemplified embodiment of a welding apparatus 1 in accordance with the invention for welding workpieces W. A welding arc SLB is ignited between a non-consumable welding electrode 2 of the welding apparatus 1 and the workpieces W to be welded and produces a molten pool. During the welding procedure, a weld metal ZW is supplied, as illustrated in FIG. 1. The non-consumable welding electrode 2 is located on a welding torch 3 which is connected to a welding current source 5 via a hose assembly 4. A gas, in particular a protective gas, can be supplied to the welding torch 3 via the hose assembly 4. The protective gas is e.g., helium or argon and mixtures thereof. Small proportions of active gases can also be added to the gas mixture. The non-consumable welding electrode 2 is e.g., a tungsten electrode. Located within the hose assembly 4 are not only the gas supply lines for the protective gas but also current or welding lines for supplying the welding torch 3 with electric current. This electric current is provided by the welding current source 5.

In the case of the welding apparatus 1 in accordance with the invention or the welding device in accordance with the invention, the welding of the workpiece W is performed in a welding process including a plurality of welding cycles SZ, the parameters of which can be set via an interface 6 of the welding apparatus 1. In the embodiment illustrated in FIG. 1, the interface 6 is provided for setting the parameters on the welding current source 5. Alternatively, or additionally, a user interface 6 can also be provided on the welding torch 3.

Each welding process includes one or a plurality of welding cycles SZ. In the case of the welding apparatus 1 in accordance with the invention, each welding cycle SZ of the welding process has a high-current welding phase HSP and a low-current welding phase NSP. During the high-current welding phase HSP, an electric welding current I having a high current amplitude flows, whereas in the low-current welding phase NSP of the welding cycle SZ, only a welding current I having a low current amplitude flows.

In the high-current welding phase HSP, with the relevant welding cycle SZ being set accordingly, current pulses for producing oscillations in the produced molten pool are additionally applied. Furthermore, at the beginning of the high-current welding phase HSP, with the relevant welding cycle SZ being set accordingly, high-frequency ignition pulses ZI are applied for the contactless ignition of the welding arc SLB in order to ionise a gap between the welding electrode 2 and the workpieces W. The current pulses are switched on in order to break the surface tension. The RPI (reverse polarity high-frequency ignition pulses) are used in order to improve the ignition properties. A polarity reversal of the welding current means a higher temperature at the tungsten electrode, as a result of which the air gap between the electrode and workpiece surface is ionised more effectively.

During the welding process, a welding job can be used which includes a plurality of welding cycles SZ. These parameters can be set via the interface 6 of the welding apparatus 1. In one possible embodiment, the parameters of the welding cycles SZ of the welding job can be set manually before or during performance of the welding process by a welder by means of a user interface, e.g., by means of the user interface 6 provided in the current source 5. In a preferred embodiment, a plurality of selectable welding jobs for setting the welding parameters thereof are located in a data memory. In one possible embodiment, this data memory is integrated in the welding current source 5. Alternatively, the data memory can also be connected to the welding current apparatus 1 via a data interface. The welding jobs can be adapted e.g., as soon as defined threshold values or trigger points of the welding job are reached.

In one possible embodiment of the welding apparatus 1 in accordance with the invention, a welding job stored in the data memory is initially read out and, after setting of the welding parameters of the various welding cycles SZ of the selected welding job, is adapted accordingly and written back to the data memory. In this manner, each welder has the option of adapting a welding job according to his own experiences and preferences and of storing said job in the data memory for further use.

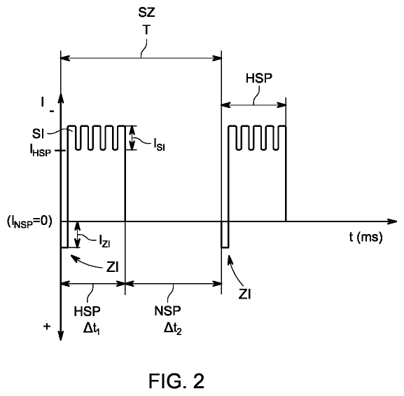

FIG. 2 shows a signal diagram for explaining the mode of operation of a method in accordance with the invention for welding workpieces W with the aid of a welding arc SLB. The welding arc SLB is ignited between the non-consumable welding electrode 2 and the workpieces W and produces a molten pool at this location. The welding of the workpieces W is performed in the welding process including settable welding cycles SZ, as illustrated in FIG. 2. Each welding cycle SZ includes a high-current welding phase HSP and a low-current welding phase NSP. During the high-current welding phase HSP, a welding current I having a high current amplitude I_{HSP} flows. In the subsequent low-current welding phase NSP, a welding current I having a low current amplitude I_{NSP} flows. If the current amplitude I_{NSP} exceeds a threshold value, a welding arc SLB is also present in the low-current welding phase. In the case of the exemplified embodiment illustrated in FIG. 2, the low current amplitude I_{NSP} is equal to zero (I_{NSP}=0 A), i.e., no arc burns. The duration of the high-current welding phase HSP is Δtᵢ and the duration of the low-current welding phase NSP is Δt₂. The duration of the settable welding cycle SZ is T=Δtᵢ+Δt₂. In the high-current welding phase HSP of the welding cycle SZ, with the relevant welding cycle SZ being set accordingly, current pulses are additionally superimposed on the high current amplitude I_{HSP} in order to produce oscillations in the molten pool, as illustrated in FIG. 2. The pulse frequency is preferably 0.2 Hz to 20 kHz. The current amplitude of the current pulses SI can be in a range of 0 A to 1100 A. Furthermore, at the beginning of the high-current welding phase HSP, with the relevant welding cycle SZ being set accordingly, high-frequency ignition pulses ZI are applied for the contactless ignition of the welding arc SLB in order to ionise a gap between the welding electrode 2 and the workpieces W. In the case of the exemplified embodiment in FIG. 2, only one ignition pulse is illustrated. However, a plurality of ignition pulses Z can also be produced at the beginning of the high-current phase HSP.

The welding cycle SZ, as illustrated in FIG. 2, includes various parameters. These parameters are a time duration Δtᵢ of the high-current welding phase HSP, a time duration Δt₂ of the low-current welding phase NSP, a ratio of the time duration Δtᵢ of the high-current welding phase HSP to the time duration Δt₂ of the low-current welding phase NSP, a current amplitude I_{HSP} of the basic welding current I flowing in the high-current welding phase HSP, a current amplitude I_{NSP} of the welding current I flowing in the low-current welding phase NSP, a ratio of the current amplitudes of the basic welding current I_{NSP} flowing in the high-current welding phase HSP to the current amplitude of the basic welding current I_{NSP} flowing in the low-current welding phase NSP, an amplitude I_{SI} and a frequency f_{SI} of the current pulses SI superimposed on the welding current I in the high-current welding phase HSP and an amplitude I_{ZI}, frequency and polarity of the ignition pulses ZI which can be applied at the beginning of the high-current welding phase HSP.

In one possible embodiment, a welder or user can set various welding parameters via a user interface 6 before or during the welding process. Furthermore, parameters of the welding cycles SZ of a welding job can be set according to the situation in dependence upon detected measurement values before or during the welding process. The current amplitudes of the welding current I in the high-current welding phases HSP can be up to 1000 amp.

In order to ignite the welding arc SLB, high-frequency ignition pulses ZI are applied at the beginning of the high-current welding phase HSP. For the purpose of igniting the welding arc SLB, different ignition processes can be performed, in particular HF-ignition. In an advantageous manner, the HF-ignition has reverse polarity (Reverse Polarity Ignition RPI). The contactless ignition procedure can be performed with the aid of high-frequency ignition pulses ZI within a plurality of pulse packets. The contactless ignition of the welding arc SLB serves primarily to ionise the distance between the welding electrode 2 and the workpiece W. After ignition of the welding arc SLB, the welding current I is switched on. High-frequency ignition pulses ZI can be applied within one or a plurality of pulse packets at a specified frequency within an ignition time duration. As a result, pre-ionisation of the air or ambient gas between the welding electrode 2 and the workpiece W is achieved and so rapid and reliable ignition of the welding arc SLB takes place. A pulse packet can include a plurality of ignition pulses, e.g., up to 500 HF-ignition pulses. The number of the ignition pulses ZI can depend upon the selected ignition duration and the frequency of the ignition pulses ZI. The coupling-in of the HF-ignition into the welding circuit can be performed e.g., capacitively (capacitor) or inductively (coil). In one possible embodiment, the frequency and number of the ignition pulses ZI can be set for different applications. By means of the ignition pulses ZI which are applied in packets, it is possible to achieve exact, reliable and rapid ignition of the welding arc SLB.

After ignition has been performed, current pulses SI are superimposed on the high current amplitude I_{HSP} in the further course of the high-current welding phase HSP in order to produce oscillations in the molten pool produced, as likewise illustrated in FIG. 2. The amplitude I_{SI} of these current pulses SI can likewise be set. The molten pool is caused to oscillate by means of the pulsed introduction of energy during the high-current welding phase HSP, by current pulses SI superimposed on the high basic welding current I_{HSP}. The oscillations of the molten pool cause the molten pool to flow together more easily between the workpieces W involved. Furthermore, the effected energy input can be controlled more precisely by means of the amplitude I_{SI} of the current pulses. In one possible embodiment, the various pulse parameters of the current pulses SI, in particular the pulse height, pulse width, pulse frequency, pulse pause and pulse shape, can be set via the user interface 6 on the current source 5.

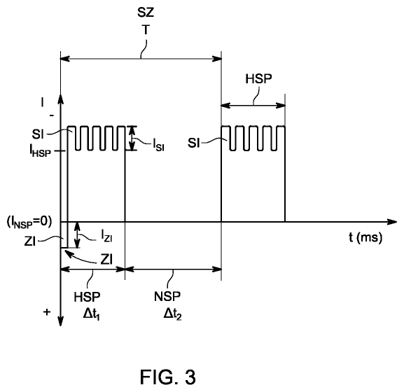

FIG. 3 shows a further signal diagram to explain the mode of operation of the welding method in accordance with the invention. In the illustrated embodiment, the application of the high-frequency ignition pulses ZI is performed only during the first welding cycle SZ. During the subsequent second welding cycle SZ, the welding arc SLB is ignited without applying high-frequency ignition pulses ZI. In the case of the exemplified embodiment illustrated in FIG. 3, the current amplitude I_{NSP} during the low-current welding phase NSP is zero (I_{NSP}=0 A) .

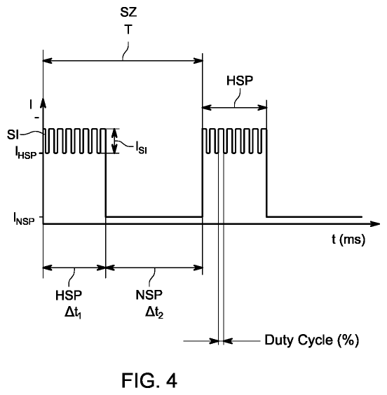

FIG. 4 shows a further exemplified embodiment of the method in accordance with the invention. In the case of the exemplified embodiment illustrated in FIG. 4, the current amplitude I_{NSP} during the low-current welding phase NSP is not zero but instead can be set in a specified range of e.g., 0 to 3 amp by the user. The time period (duty cycle) of the superimposed current pulses SI during the high-current welding phase HSP is likewise illustrated in FIG. 4 and, in one possible embodiment, can be set accordingly by the user in order to control the energy input. The more pulses are set, the higher the energy input is. In the case of this exemplified embodiment, the welding arc SLB is ignited without applying high-frequency ignition pulses ZI.

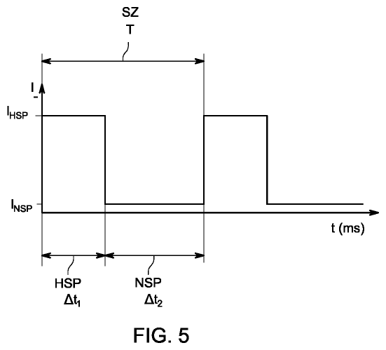

FIG. 5 shows a further exemplified embodiment of the method in accordance with the invention. In the case of this embodiment, a welding current I having a low current amplitude I_{NSP} in a range of 0 to 3 amp likewise flows during the low-current welding phase NSP. In the case of the exemplified embodiment illustrated in FIG. 5, current pulses SI are not superimposed on the high current amplitude I_{NSP} during the high-current welding phase HSP. The current pulses SI and the high-frequency ignition pulses having a positive polarity ZI can thus preferably be switched on or off, depending upon the application and preference of the user.

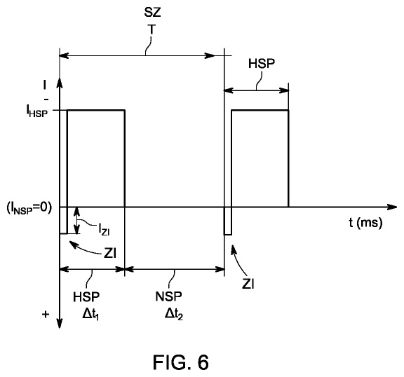

FIG. 6 shows a further exemplified embodiment of the method in accordance with the invention. In the case of the illustrated exemplified embodiment, there is no current flow (I_{NSP}=0 A) during the low-current welding phase NSP.

Furthermore, the welding arc SLB is ignited in each case at the beginning of each welding cycle SZ (Reverse Polarity Ignition RPI) by means of HF-ignition pulses ZI.

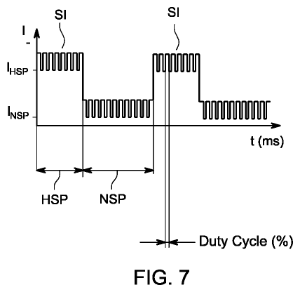

In the case of the exemplified embodiment illustrated in FIG. 7, current pulses SI are applied both in the high-current welding phase HSP and in the low-current welding phase NSP.

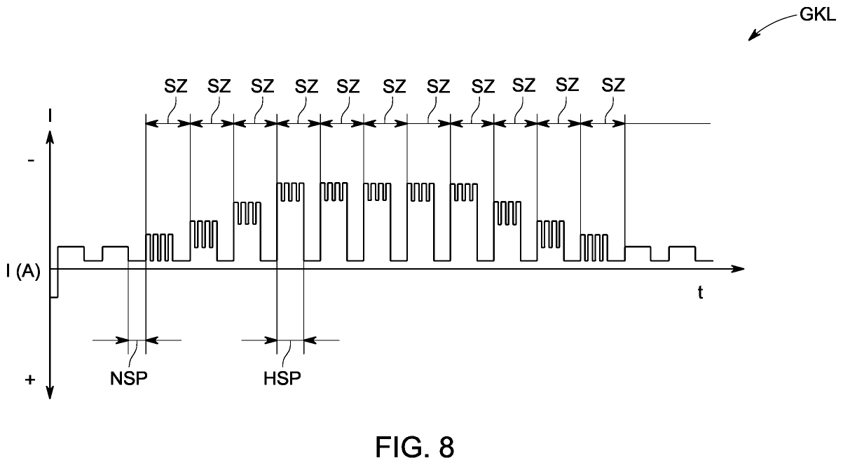

FIG. 8 shows a further signal diagram to explain the mode of operation of the method in accordance with the invention. FIG. 8 shows a plurality of welding cycles SZ which overall form a possible welding job. In the case of the illustrated exemplified embodiment, the current amplitudes I_{NSP} of the high-current welding phases HSP of welding cycles SZ within the welding jobs increase in a ramp-like manner at the start and remain constant over a plurality of welding cycles SZ and decrease in a ramp-like manner at the end. In one possible embodiment, the welding parameters of the various welding cycles SZ included within the welding job can be individually set. In a further possible embodiment, a specified basic characteristic curve GKL, e.g., as illustrated in FIG. 8, can be read out from a data memory and optionally can be adjusted or set for the relevant application by a welder before or during the welding process. In one possible embodiment, a basic characteristic curve or welding job read out from a data memory can be written back to the corresponding data memory after the welding parameters have been set by a user as an adapted welding job. The data memory can be provided e.g., in the welding current source 5 of the welding device. The correspondingly adapted welding job can be written back to the data memory as a database entry by the relevant user and can then be used by the user for subsequent welding processes. In this manner, a user has the option of individualising a basic welding characteristic curve GKL for his specific requirements and preferences and of reading said curve out from the data memory for welding processes as required. The welding method in accordance with the invention permits reliable ignition of the non-consumable welding electrode 2 and precise setting of the energy input during a welding process. This can increase the quality of the welding seam produced.

In one possible embodiment, the welding device 1 has a graphical user interface 6 having a display unit. The graphical user interface 6 can be integrated e.g., in the welding current source 5. Alternatively, a user interface 6 can also be provided on the welding torch 3 or on a portable device which communicates with a controller of the welding device 1. The user interface 6 includes e.g., a touch-screen which allows the user or welder to individually set the various welding parameters of the various welding cycles SZ of a welding job. In a preferred embodiment, the welding job including the individual welding cycles SZ is displayed on the display unit of the user interface 6 and can be adapted by the user for his own purposes. For example, in one possible embodiment the welding job illustrated in FIG. 8 is displayed to the user via the display unit. The user, by correspondingly actuating the touch-screen, can zoom into specific points of the welding job, e.g., specific phases (HSP, NSP) of an individual welding cycle SZ. For example, by moving two fingers in the opposite direction it is possible to zoom into or focus on a specific point within the welding job in order to manually set specific welding parameters at this location. For example, a user can reduce or extend or increase the amplitudes and time durations or time periods on the touch-screen by means of corresponding finger movements. This allows the user to rapidly and intuitively adapt the corresponding welding jobs. For example, a user can set or deactivate ignition pulses ZI or ignition pulse packets at the beginning of the welding cycle SZ individually for various welding cycles SZ by means of a manual input command, e.g., tapping on the surface of the touch-screen. The amplitude of the superimposed current pulses SI can also be adapted individually by a corresponding input by the user for each welding cycle SZ of the welding job. This allows simple and flexible adaptation of the welding job or characteristic curve for the welder and thus optimum adaptation for the respective application. The amplitude, frequency and polarity of the ignition pulses ZI applied at the beginning of the high-current welding phase HSP can be selected manually e.g., by the user.

1. A method for welding workpieces with a welding arc which is ignited between a non-consumable welding electrode and the workpieces and produces a molten bath,
wherein the welding of the workpieces is performed in a welding process including settable welding cycles,
which each have a high-current welding phase, during which a welding current having a high current amplitude flows, and
a low-current welding phase, during which a welding current having a low current amplitude flows,
wherein in the high-current welding phase of the welding cycle, with the relevant welding cycle being set accordingly, current pulses are applied to the high current amplitude, and
wherein, at the beginning of the high-current welding phase, with the relevant welding cycle being set accordingly, reverse polarity high-frequency ignition pulses are applied for the contactless ignition of the welding arc.

2. The method as claimed in claim 1, wherein a welding job used in the welding process includes a plurality of welding cycles, the parameters of which are set via an interface.

3. The method as claimed in claim 2, wherein the parameters of a welding cycle of the welding job have:
a time duration of the high-current welding phase,
a time duration of the low-current welding phase,
a ratio of the time duration of the high-current welding phase to the time duration of the low-current welding phase,
a current amplitude of the welding current flowing in the high-current welding phase,
a current amplitude of the welding current flowing in the low-current welding phase,
a ratio of the current amplitudes of the welding current flowing in the high-current welding phase to the current amplitude of the welding current flowing in the low-current welding phase,
an amplitude and a frequency of the current pulses applied in the high-current welding phase and/or low-current welding phase,
an amplitude, frequency and polarity of the ignition pulses which can be applied at the beginning of the high-current welding phase.

4. The method as claimed in claims 1, wherein the level of the welding current is set in such a manner that a welding arc is present in the low-current welding phase.

5. The method as claimed in claims 1, wherein parameters of the welding cycles of a welding job are set manually by a welder by means of a user interface before or during the welding process.

6. The method as claimed in claim 1, wherein current amplitudes of the high-current welding phases of welding cycles within a welding job increase in a ramp-like manner at the start, then remain at a constant level and decrease in a ramp-like manner at the end.

7. The method as claimed in claim 1, wherein the current amplitudes of the high-current welding phases are up to 1000 amp and/or wherein the current amplitudes of the low-current phases range from 0 to 100 amp.

8. The method as claimed in claims 1, wherein the current amplitude of the welding current flowing in the low-current welding phase of the welding cycle is set in a range between 0 and 10 amp.

9. The method as claimed in claim 1, wherein the high-frequency ignition pulses are applied within one or a plurality of pulse packets at a specified frequency within an ignition time duration, wherein a pulse packet includes a plurality of ignition pulses.

10. The method as claimed in claim 1, wherein additionally in the low-current welding phase of the welding cycle, with the relevant welding cycle being set accordingly, current pulses are applied to the high current amplitude.

11. A welding apparatus for welding workpieces, comprising:
a non-consumable welding electrode;
a welding torch, on which the non-consumable welding electrode is located;
a welding current source, to which the welding torch is connected via a hose assembly, wherein protective gas can be supplied to the welding torch via the hose assembly and wherein lines for supplying the welding torch with electric current from the welding current source are located in the hose assembly;
a data memory, in which a plurality of selectable welding jobs are located, wherein each welding job includes a plurality of welding cycles of a welding process for welding the workpieces,
wherein each welding cycle of the welding process has a high-current welding phase, during which a welding current having a high current amplitude flows, and a low-current welding phase, during which a welding current having a low current amplitude flows,
wherein in the high-current welding phase of the welding cycle, with the relevant welding cycle being set accordingly, current pulses are applied to the high current amplitude, and wherein, at the beginning of the high-current welding phase, with the relevant welding cycle being set accordingly, reverse polarity high-frequency ignition pulses are applied for the contactless ignition of the welding arc; and
an interface, via which a welding job can be selected from the data memory and parameters of the welding cycles of the welding job can be set;
wherein the welding apparatus is designed, in order to weld the workpieces, to ignite a welding arc between the non-consumable welding electrode of the welding apparatus and the workpieces and to produce a molten pool, and to perform a welding process including a plurality of welding cycles according to the parameters of the welding cycles of the welding job set via the interface.
